(19) United States
(12) Patent Application Publication
(10) Pub. No.: US 2007/0100963 A1
(43) Pub. Date: May 3, 2007

(54) Remote Content Storage for Mobile Telephones

(75) Inventors: Gary Edward Ban, Cary, NC (US); Juan Antonio Pons, Pittsboro, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Oasys Mobile, Inc., Raleigh, NC (US)

(21) Appl. No.: 11/428,745

(22) Filed: Jul. 5, 2006

Related U.S. Application Data
(60) Provisional application No. 60/732,313, filed on Nov. 1, 2005.

(51) Int. Cl. G06F 15/16

(52) U.S. Cl. 709/217

(57) ABSTRACT

A system for managing mobile telephone content provides a locker to a user. The locker includes pointers or references to mobile telephone content that is stored in a central location or at a remote third party location. The system further stores mobile telephone attributes for different mobile telephones. When the system receives a request from the user to download the mobile telephone content to the user's mobile telephone, the system retrieves the content based on the user's current mobile telephone attributes for the user's mobile telephone. The system then initiates a transfer of the content via a wireless carrier to the user's mobile telephone

### FIELD OF THE INVENTION

One embodiment of the present invention is directed to mobile telephones. More particularly, one embodiment of the present invention is directed to remote content storage for mobile telephones.

### BACKGROUND INFORMATION

Mobile wireless telephones/devices, such as cellular telephones, personal digital assistants (“PDA”s) that include telephone capabilities, handheld computers that include telephone capabilities, etc, have become increasingly popular and are used by a large portion of the population. Many current mobile telephones are now able to connect wirelessly to the Internet. Mobile telephones usually have a set of ringtones, games, wallpaper and other applications that are preprogrammed into the phone by the manufacturers of the phones. Typical mobile telephones also have usable memory in which a user may store additional data files, such as ringtones, wallpaper, games, images, sound, and other applications and files that are implemented on the telephones (collectively referred to as “content”) which originate elsewhere. Thus, if the user desires content that has not been preprogrammed into the telephone, the user may download into the usable memory of the telephone the desired software.

However, users change mobile telephones such as cellular telephones frequently. For example, an existing cellular telephone may become broken or lost, or a user may upgrade their telephone to get a telephone with more features or merely because the user is tired of their existing telephone. Many cellular carriers encourage users to frequently change telephones by offering sharply discounted telephones every few years during the user's cellular telephone service contract or at a renewal period.

One problem when the user changes telephones is that all of the content that the user downloaded on the old telephone will be lost. Much of the content was purchased by the user, and should still be legally owned by the user even if the user switches telephones. However, there does not exist many easy technical solutions for transferring customer owned content to new telephones, and in addition there are frequent formatting issues with the content if the new telephone is from a different cellular carrier or manufacturer, or has a different architecture and/or operating system from the old telephone or even if it is a new model of the existing brand of telephone.

Further, a user may own more content than can be stored at once on a mobile telephone. In this case, the user would need an alternate location to store content other than directly on the mobile telephone.

Some prior art solutions to the above problems store copies of all of a user's content in a location remote from a user's telephone. However, these known solutions require, for each user, a stored copy of the content at the location and do not allow content to be stored remotely by third party owners of the content. When the number of users grow in these known prior art solutions, the amount of storage requirements consequently grows exponentially.

Based on the foregoing, there is a need for a system and method for reducing the storage requirements of user content, for allowing user content to be remotely available from the user's telephone, and for facilitating a seamless way to retrieve the content for a user's telephone, even when a user switches telephones.

### SUMMARY OF THE INVENTION

One embodiment of the present invention is a system for managing mobile telephone content. The system provides a locker to a user. The locker includes pointers or references to mobile telephone content that is stored in a central location or at a remote third party location. The system further stores mobile telephone attributes for different mobile telephones. When the system receives a request from the user to download the mobile telephone content to the user's mobile telephone, the system retrieves the content based on the user's current mobile telephone attributes for the user's mobile telephone. The system then initiates a transfer of the content via a wireless carrier to the user's mobile telephone

### BRIEF DESCRIPTION OF THE DRAWINGS

FIG. 1 is a block diagram of a communication system that implements the present invention in accordance with one embodiment.

FIG. 2 is a flow diagram illustrating the typical functionality in the system when a registered user purchases content or downloads previously purchased content from a user locker in accordance with one embodiment of the present invention.

FIG. 3 is a flow diagram illustrating the functionality in the system when performing content compatibility verification including DRM control in accordance with one embodiment of the present invention.

FIG. 4 is a flow diagram illustrating the functionality in the system when delivering locker content to a mobile telephone after changing PCH in accordance with one embodiment of the present invention.

FIGS. 5-10 illustrate an example of retrieving wallpaper or other content that is formatted, and applications and other content that is merely mapped in accordance with an embodiment of the present invention.

### DETAILED DESCRIPTION

One embodiment of the present invention is a content storage area and an individual reference area for each user (referred to as a “locker”) that provides references or pointers to the portions of the content storage area that corresponds to the user's owned content. The content can be repeatedly downloaded to the user's mobile wireless telephone, regardless of the type of telephone or the formatting requirements of the telephone, based on compatibility and download rules.

Embodiments of the present invention provide mobile users the ability to manage their purchased mobile content online, including ringtones, wallpapers, and mobile applications. For each user, a user locker having references to the actual stored content is created for the user account automatically.

In one embodiment, when a user purchases content, a physical file of the content is delivered electronically to the user's phone or other mobile telephone. Upon successful download of the content by the user, embodiments of the present invention store the reference or pointer to the parent item of the delivered physical content (i.e., the content's “master”), in the user's locker. This master item is an abstract representation of the purchased content. Each master item may have multiple children items, disclosed in more detail below, each for a specific phone model/carrier

By storing the reference or pointer to an abstract representation of the purchased item in the locker, embodiments of the present invention make it efficient to support user transfer of the purchased item to a different phone or carrier without having to store individual copies of the content for each user. Each time a user visits their locker, embodiments of the present invention verify the compatibility and availability of the user's locker content items against the handset and carrier information stored in the user's account profile. For each item in the locker, if a child item is found for the specified phone model and/or carrier, the content is said to be compatible and available with the user's current handset model and carrier, and thus is marked as downloadable. Otherwise, it is marked as non-compatible. When the user requests a download, the appropriately formatted or type of content file for the requesting phone/carrier is retrieved or created on-the-fly (e.g., for wallpaper) for the user's phone. Subject to the download rules and Digital Rights Management (“DRM”), a user can repeatedly re-download the appropriate content file based on the entry in the locker content to a phone. Further, in one embodiment, a user can also browse the public content of other registered users' lockers and purchase the correctly formatted content for their phone.

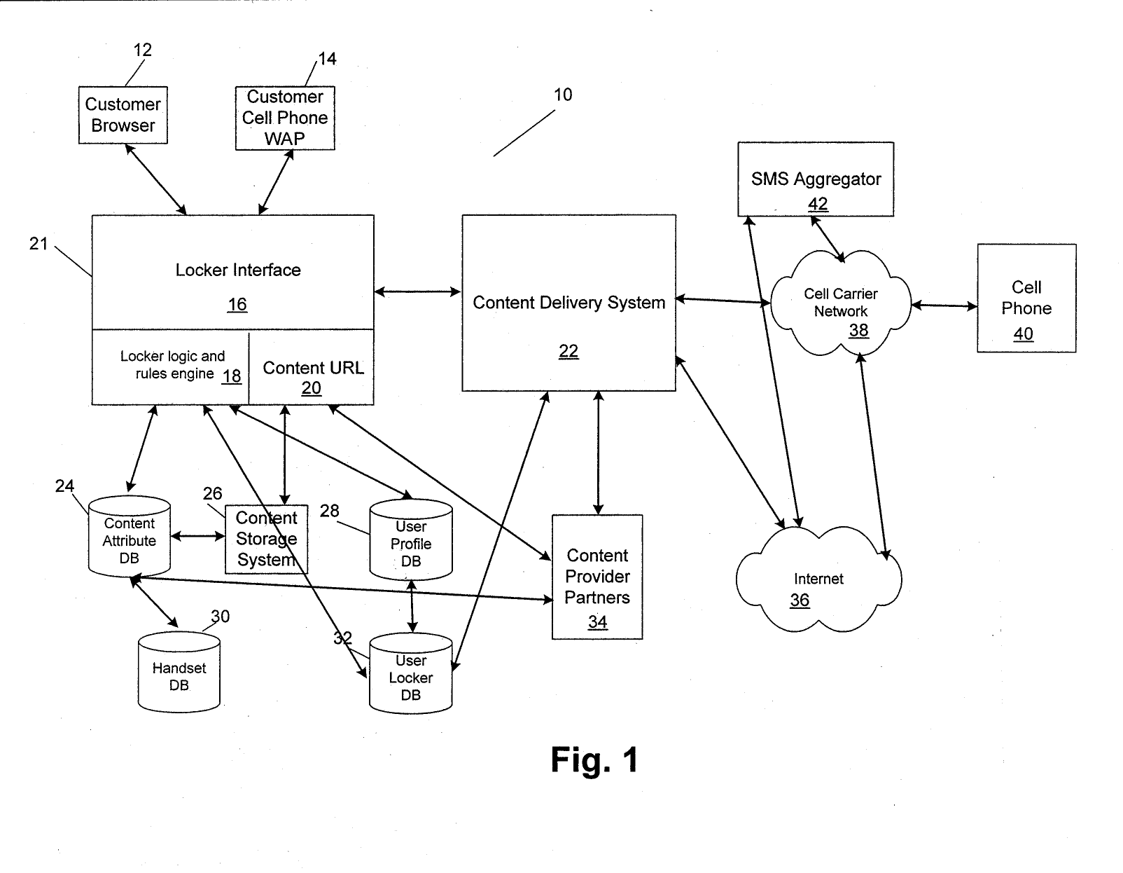

FIG. 1 is a block diagram of a communication system 10 that implements the present invention in accordance with one embodiment. System 10 is a platform for mobile content distribution and services, and provides the infrastructure for storing, managing, conversion and distribution of multimedia content and applications to mobile end users. System 10 includes a locker server 21. In one embodiment, locker server 21 includes a processor for executing instructions, and memory for storing instructions to be executed. A user may access locker server 21 through the Internet via a browser on a computer 12, or a cellular telephone, via a Wireless Application Protocol (“WAP”) on a cellular telephone 14, or via any other known method for accessing a web site on a server. Locker server 21 includes a locker interface 16 that provides a front end interface to the user attempting to access a locker, Uniform Resource Locators (“URL”s) 20 for each of the available content, and a locker logic module and rules engine 18 that provides logic for ringtones, games, applications and other content available to the user. Locker interface 16 generates and provides a “dashboard” for each user that allows the user to manage and edit their locker. Cellular telephone 14 may be any known mobile telephone that communicates with a cellular network.

User interface 16 is coupled to various databases and storage systems 24, 26, 28, 30 and 32 that store content, content attributes, and user information. Although in one embodiment, the various databases 24, 26, 28, 30 and 32 are disclosed as separate databases, in other embodiments the functionality can be implemented on a single database, or any other combination of databases. Databases 24, 26, 28, 30 and 32 in one embodiment are a collection of information organized in such a way that a computer program can quickly select desired pieces of data.

In one embodiment, locker interface 16 is coupled to databases 24, 26, 28, 30 and 32 via PHP: Hypertext Preprocessor which is an embedded scripting language used to create dynamic Web pages. A content attribute database 24 stores attributes such as download rules, DRM attributes, formats, etc. Content storage system 26 stores all content that is local to locker server 21. Other content, disclosed below, may be stored and maintained by third party content providers 34. A user profile database 28 maintains a profile for each user/customer of system 10, including account information, usernames and passwords, telephone numbers, telephone types, carrier information, etc. A user locker database 32 stores one or more lockers for each user. As disclosed above, a locker is generally a set of references to content owned by the user. A telephone/handset database 30 stores attributes of all handsets or cellular telephones to which users download content. Attributes for each handset include operating systems, architectures, screen size, memory capacity, type of audio codecs, etc.

A content provider partners module 34 is coupled to content attribute database 24. Content provider partner module 34 is an interface to content that is stored and controlled by third party providers, but that is available to users of system 10.

Locker server 21 is coupled to a content delivery system 22. Content delivery system 22 receives user requested content from locker server 21, and maps or formats the content for delivery to the user's cellular telephone 40. Content delivery system 22 can includes its own handset database, a Wireless Application Protocol (“WAP”) or Multimedia Message Service (“MMS”) services engine, HTTP or sockets, a list of URLs for the content retrieval, a coupled to Short Message Service (“SMS”) aggregator facilities 42, SMS, and other elements that allow it to send the data to telephone 40 and allows a user to pay for content from telephone 40 using SMS (“PSMS”). Content delivery system 22 communicates via PSMS to the cellular carrier network 38 that corresponds to cellular telephone 40 for billing purposes. Other payments methods include credit card, Paypal or other Internet based payment methods, user credits, etc. Carrier network 38 can be any wireless cellular network such as the Verizon network, AT&T network, Sprint network, etc. Content delivery system 22 further communicates through the Internet 36 to direct URLs of specific content storage to network 38 for delivery. Thus, requested content is sent via Internet 36 to network 38, and it is then downloaded to telephone 40.

In one embodiment, user locker database 32 stores user lockers as a set of data records organized as relational tables in a relational database. In one embodiment, a locker has the following properties: Each user locker is assigned a readable “name” and is uniquely identified by its locker ID. Each user locker is associated with a user or account. Each user locker has a “type”. There can be many different types of lockers. For example, the user locker for storing purchased items may have the type “Purchased”. A user can have several lockers of various types. A user locker may be designated either “public” or “private”. In usage, a public locker could be made visible for others to see. A private locker could be hidden from public and is accessible only by the owner. Each user locker type can have a quota on the number of content items it can have and/or a quota on the kilobytes of disk space these items can take up aggregately. The actual values of the quotas may be dependent on the user account type or other variables.

Content items stored in a user locker are organized logically into a hierarchical structure. In one embodiment, a “locker group” data model is used to represent this organization structure. The mobile content stored in a user locker in one embodiment is represented by a “locker item” data model. In one embodiment, a locker item has the following properties. A locker item is uniquely identifiable by its ID. A locker item always belongs to a locker group. A locker item contains a reference to a content item in the content item database. A locker item has a data type (e.g., wallpaper, ringtone, applications). A locker item stores the meta data about the mobile content.

In one embodiment, all mobile content is represented as content items in system 10. The basic properties of a content item are as follow. An item is identifiable by its item ID and assigned a readable name. Each item belongs to a content category. Each item has an encoding type (e.g., audio/MP3, video/MPEG). An item contains the meta data about the actual mobile content. An item could have multiple items as its children items. An item can be a child of another item. This induces a nested relation among items in the database. This nested relation is typically used to define an abstract “master” content and its various specific versions. For example, a ringtone “A” may have multiple formats (e.g., MP3, AMR, and QCP) for different handsets. In this case, all versions of the ring-tone “A” are children items of the abstract ring-tone “A”. When storing a content item in a user locker, if the item has multiple items as children, the locker stores the reference to its parent master item.

In one embodiment, an item category data model is also defined, which is used to represent content groupings of different items in the database. The item category data model provides a logically grouping of content into a hierarchical categories structure (e.g., Ringtones, Wallpapers, Downloadable applications). A content category may be nested. For example, content category “Ring Tones” may be broken down into subcategories “Classical”, “Comedy”, “Country”, “World Music”, etc.; each of which may be further broken down into subcategories (“World Music” to “East Asian”, “South America”, etc.).

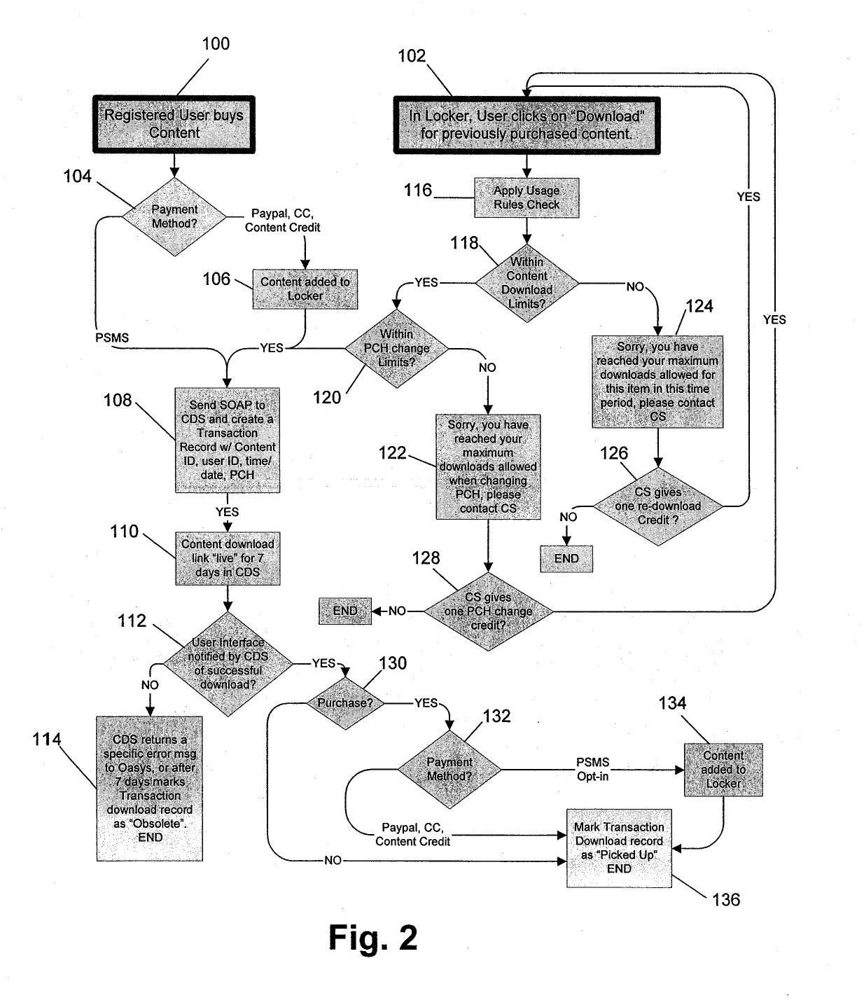

In system 10, accessing a user locker may be through a dashboard or other means of locker interface 16 and may occur, for example, when a user desires to desires to retrieve or reinstall locker content to a handset. FIG. 2 is a flow diagram illustrating the typical functionality in system 10 when a registered user purchases content (100) or downloads previously purchased content (102) from a user locker in accordance with one embodiment of the present invention. The functionality of FIG. 2 is implemented by software stored in memory and executed by a processor. In other embodiments, the functionality can be performed by hardware, or any combination of hardware and software.

When a registered user purchases content that is selected from the web site of user interface 21 or other means, the payment method is determined (104). Possible payment methods, typically executed from the browser 12, include Paypal or other Internet-based payment systems, credit cards, or existing user credit. If these payments are used, the content is added to the user's locker (106). Otherwise, carrier billing is executed via PSMS and the content is added to the locker later in the process.

At 108, a Simple Object Access Protocol (“SOAP”) message is sent to Content Delivery System (“CDS”) 22 to create a transaction record with a content ID, user ID, time/date of purchase, and the Phone Number, Carrier and Handset (“PCH”) used to track downloads to different entities. The locker has rules for the number of re-downloads in a period of time (configurable). PCH is used to track re-downloads to entities other than the original or previous setups.

At 110, the content link is available for downloading content for seven days (or another predetermined number of days) to CDS 22. At this point, the user at telephone 40 can download the data by clicking on the link received by the phone from CDS 22.

At 112, it is determined if the user successfully downloaded the content from CDS 22 within the specified time limit. If not, an error message is returned to user interface 21, or the transaction download record is marked as “Obsolete” (114). If so, it is determined if the download is considered a purchase that must be paid for, as opposed to content that was already paid for and is merely being re-downloaded (130). If not being purchased, functionality goes to 136 where the transaction download record is marked as “Picked Up”.

At 132 the payment method is determined from 104. If non-PSMS, functionality goes to 136. IF PSMS opt-in, which indicates that payment has been made via carrier billing, the content is added to locker 134, and then functionality goes to 136. This insures that the content is not added to the user's locker until payment has been made.

If previously purchased content is being downloaded, while within the user's locker, the user clicks on “Download” for the desired content (102). Download rules for the content, such as number of allowed downloads, is then checked (116). Based on these rules, at 118 it is determined whether the user is within the content download limits. If yes, at 120 it is determined whether the user is within PCH change limits. PCH change limits are limits to how many times a user may change telephone numbers, wireless carriers or telephone types. If the user is within the limits, functionality moves to 108. If the user is not within the change limits, a message is displayed stating that the user has reached their maximum downloads, and the user should contact a system administrator or customer service (“CS”)

After contacting CS, the user may be given one or more PCH change credits (128). If yes, functionality returns to 102.

If it is determined at 118 that the user is not within their content download limits, a message is displayed at 124 stating that the user has reached their maximum download allowed for this item, and the user should contact CS. After contacting CS, the user may be given one or more re-download credits (126). If yes, functionality returns to 102.

One embodiment of the present invention provides a set of programs for accessing the locker database. The operations may include: (1) Add a locker item; (2) Delete a locker item; and (3) Update locker database.

The add a locker item operation adds a new locker item to a user locker. This operation may be triggered when a user purchases a piece of mobile content. The following steps are performed to add content to a user locker: (1) Check if the item is not already in the locker; (2) Determine which locker group to save the item to; and (3) Insert the content info into the locker item table.

The delete a locker item operation deletes a locker item from a user locker. The following steps are performed to delete a locker item from a user locker: (1) Determine the locker item ID of the item to be deleted; (2) Remove the locker item from the table; and (3) Remove any ancillary files associated with the item.

The update locker database operation is used to update the fields of a locker item record. For example, each time a user downloads a locker item to the handset, a field for the locker item may be updated with the latest timestamp.

One embodiment of the present invention applies a set of procedures to ensure the security, usability, and integrity of content accessed from user lockers. Currently, the access control includes the following: (1) Login control; (2) Content compatibility verification; (3) DRM control; and (4) Download rules control.

For login control, access to user lockers in one embodiment requires a properly validated user ID. Only registered users who are logged into system 10 are therefore able to access their lockers and browse the lockers of others. In another embodiment, a locker can be designated as “public” by the locker's owner, which will allow it to be viewed by anyone, even if not logged into system 10.

For content compatibility, embodiments of the present invention provide a mechanism for verifying the compatibility of a content item on a specific phone. Compatibility is determined as follows in one embodiment.

All wallpaper is compatible with all phones. The compatibility of ringtones on a handset is determined based on the model of the requesting handset, the supported encoding types of the handset model, and the available encoding types of the ringtone item as defined by an item content type ID field. One embodiment stores each ringtone item as a master (parent) record and several child records in the item database. The master record represents the abstract description of the ringtone item. Each child record is for a specific encoding type (e.g., QCP, MP3, AAC, etc.). A model content type data model can be defined to represent the information of supported encoding types of ringtones for a specific handset model. Each handset could be compatible with one or more item content types. If a ringtone item has a child whose item content type ID matches an item content type ID of the handset, then the ringtone item is compatible for the handset model.

Downloadable applications in one embodiment include J2ME or BREW applications. The compatibility of downloadable applications is determined by the model of the requesting handset, the wireless carrier of the user, and the available builds of the application. System 10 stores each downloadable application as a master (parent) record and several child records in the item database. The master record represents an abstract description of the application and each child record is a build for particular handset for a particular carrier.

Embodiments of the present invention also provide a mechanism for DRM of the content. DRM is based on the DRM support of handsets and the DRM requirements of vendors and the capability of the wireless carrier network.

Handset DRM support is controlled at the handset level in one embodiment, and multiple DRM types are supported per handset. Examples of DRM types that a handset may support include OMA DRM 1.0, OMA DRM 2.0, Nokia Forward Lock, Verizon Forward Lock, Yamaha SMAF “transfer” flag. Additional DRM types may be added to the database. Vendor DRM requirements are controlled at the vendor level.

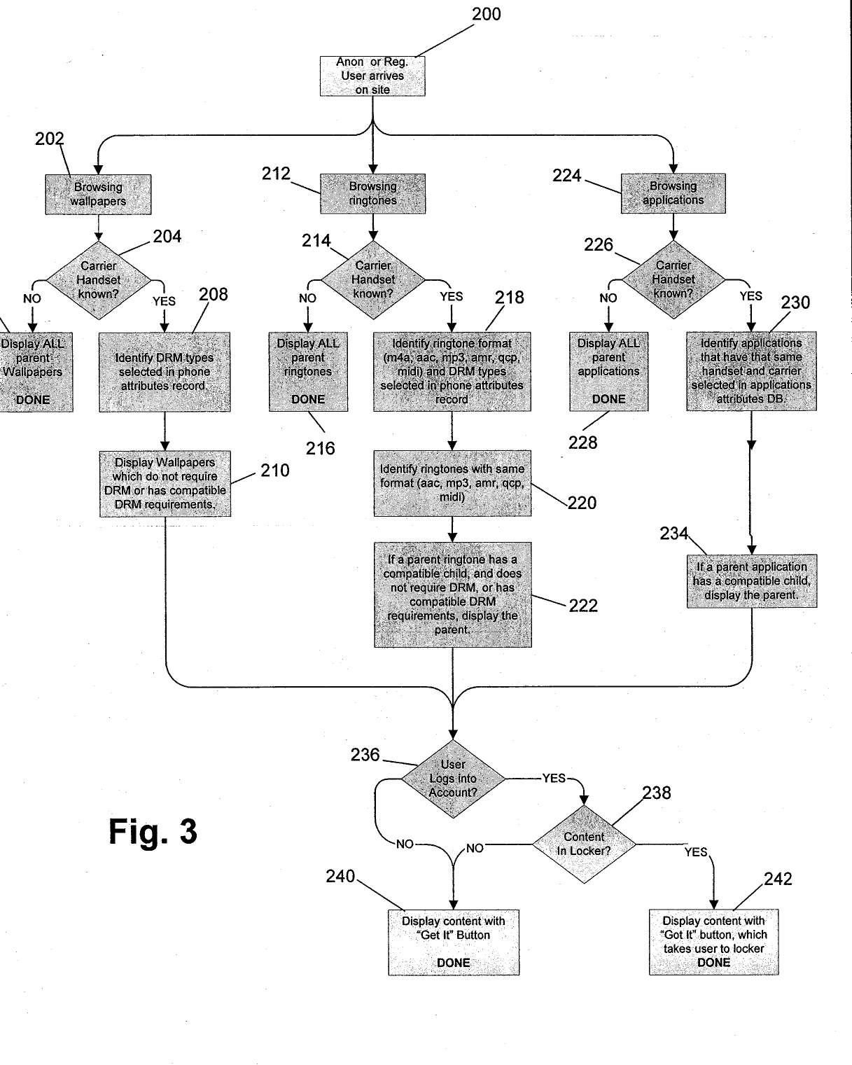

FIG. 3 is a flow diagram illustrating the functionality in system 10 when performing content compatibility verification including DRM control in accordance with one embodiment of the present invention. The functionality of FIG. 3 is implemented by software stored in memory and executed by a processor. In other embodiments, the functionality can be performed by hardware, or any combination of hardware and software.

At 200, a non-registered user or a registered user arrives at the web site of system 21. If a registered user, the user may logon to the system at 200. If the user browses available wallpaper (202), it is first determined if the carrier and handset type of the user is known (204). This information may be entered by the user at 200, or may be stored if a registered user logs on.

If the carrier and handset type are not known, all parent wallpapers are displayed to the user at 206. The user will not be able to download wallpaper at this point until the carrier and handset type are known. If the carrier and handset type are known, at 208 the DRM types are identified in the phone attributes record, and at 210 all wallpapers which do not require DRM or which have compatible DRM requirements are displayed. Functionality then moves to 236.

Similarly, if the user browses available ringtones (212), it is first determined if the carrier and handset type of the user is known (214). This information may be entered by the user at 200, or may be stored if a registered user logs on.

If the carrier and handset type are not known, all parent ringtones are displayed to the user at 216. The user will not be able to download ringtones at this point until the carrier and handset type are known. If the carrier and handset type are known, at 218 the ringtone format and DRM types are identified in the phone attributes record. At 220, all ringtones with the same format are identified. At 222, the parent ringtone is displayed if the parent ringtone has a compatible child and does not require DRM, or has compatible DRM requirements. Functionality then moves to 236.

Finally, if the user browses available games or other applications (224), it is first determined if the carrier and handset type of the user is known (226). This information may be entered by the user at 200, or may be stored if a registered user logs on.

If the carrier and handset type are not known, all parent applications are displayed to the user at 228. The user will not be able to download applications at this point until the carrier and handset type are known. If the carrier and handset type are known, at 230 all applications are identified that have the same handset and carrier selected in the applications attributes database. At 234, the parent application is displayed if the parent application has a compatible child. Functionality then moves to 236.

At 236, it is determined if the user has logged into the account. If no, the content with a “Get It” button is displayed (240). When the user selects the Get It Button, the user will be required to log on, or enter carrier and handset information, and a reference/pointer to the content will be added to the user's locker.

If the user has logged on at 236, it is determined if a reference to the content is in the locker at 238. If not, functionality goes to 240 where the user has an option to purchase the content. If the reference to content is in the locker, at 242 the content with a “Got It” button is displayed.

Downloading content from one embodiment of the present invention is controlled by locker download rules. The download rules define the extent and limit a user can download or reinstall the content in a locker to handsets. Locker download rules are based on the use history of the content in the locker. System 10 keeps records of all transactions of a user purchasing and downloading content in user profile database 28 or in user locker database 32.

The download rules may be defined as a set of logic expressions. One embodiment implements the following expressions:

Content Rule: A user is allowed to re-download a locker content item “u” number of times every “v” days. More specifically, let:
Lᵢ be the requested locker item,
Uₖ be the user id of the requester,
D be the day of request,
u, v be two integers,
Let N=the number of entries in the user_item_history database whose fields satisfy the following conditions:
   User_id=Uₖ
   locker_item_id=Lᵢ,
   status=‘PICKUP’
   date_send⊂[D, D-v]

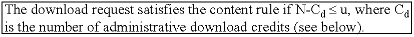

PCH Rule: A user is allowed to re-download a locker content item to a new handset or a new phone number or a new carrier “w” numbers of times every “x” days. More specifically, let:
Lᵢ be the requested locker item,
Uₖ be the user id of the requester,
D be the day of request,
x, w be two integers
Let {rᵢ} be the set of entries in the user_item_history whose fields satisfy the following conditions:
   User_id=Uₖ
   status=‘PICKUP’
   date_send⊂[D, D-x]
   If rₙ and rₘ ε{rᵢ} then at least one of the following conditions is true:
phone_number of (rₙ)≠phone_number of (rₘ)
model_carrier_id of (rₙ)≠model_carrier_id of (rₘ)

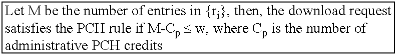

The parameters of “x”, “y” “u”, “v” and “w” in the above rules may be set and can be modified by a system administrator of system 10. By default, the download rules are applicable to all user lockers. Additional rule expressions may be introduced in other embodiments.

Administrative Credits: Locker access control also provides a mechanism for administrative overriding or modification of the basic download rules. In one embodiment, systems 10 includes an administrative crediting modification rule. An administrator can give a “download credit” or a “PCH credit” to a user. An administrative credit is recorded in the user profile database 28.

In one embodiment, the number of administrative download credits is computed as follow:
Let Lᵢ be the requested locker item,
Uₖ be the user id of the requester,
D be the day of request,
v be an integer,
then,
Cd=the number of entries in the user_item_history whose fields satisfy the following:
   User_id=Uₖ
   locker_item_id=Lᵢ
   txn_type_code=‘ADMINISTRATIVE_DOWNLOAD_CREDIT’
   date_send⊂[D, D-v]

Similarly, the number of administrative PCH credits is computed as follow:
Uₖ be the user id of the requester,
D be the day of request,
x be an integer,
then,
Cp=the number of entries in the user_item_history whose fields satisfy the following:
   User_id=Uₖ
   txn_type_code=‘ADMINISTRATIVE_PCH_CREDIT’
   date_send⊂[D, D-x]

Download Rule Override: The above download rules are default system rules applied to all content in one embodiment. Embodiments also provide a mechanism for overriding the general download rules for individual cases. In one embodiment, the content download rules can be overridden based on specific vendor, content pricing tier or items. The maximum number of downloads can be defined for a given time period for individual items, for individual vendors, and for different pricing tiers of vendors. In applying content usage verification, the content download rules specified for individual items or vendors can take precedent over the default content download rules disclosed above.

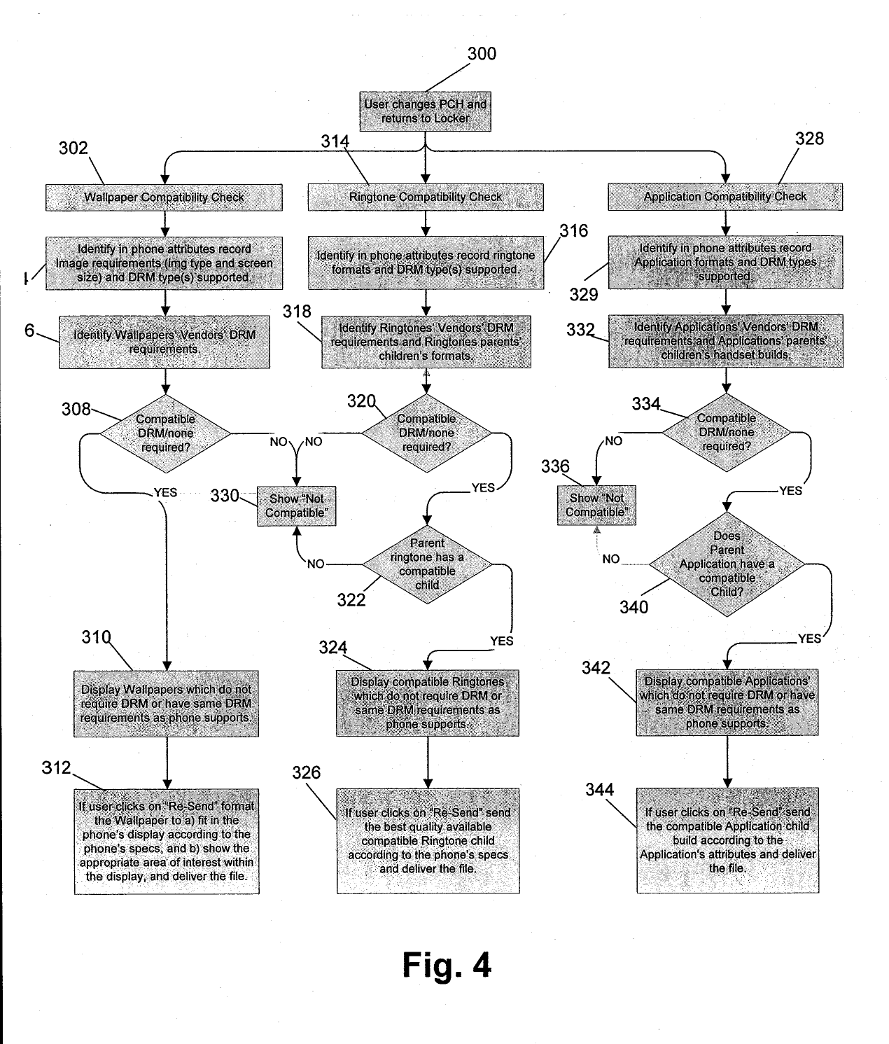

FIG. 4 is a flow diagram illustrating the functionality in system 10 when delivering locker content to cellular telephone 40 after changing PCH (300) in accordance with one embodiment of the present invention. The functionality of FIG. 4 is implemented by software stored in memory and executed by a processor. In other embodiments, the functionality can be performed by hardware, or any combination of hardware and software.

The wallpaper compatibility is checked (302) by identifying in the phone attributes record of handset database 30 the image requirements and DRM types supported (304).

The wallpapers vendors' DRM requirements are identified (306) and it is determined if the telephone has compatible DRM or if no DRM is required (308). If yes, the wallpaper is displayed that does not require DRM or has the same DRM requirements that are supported by the telephone (310). A “resend” button will also be displayed. If the user clicks on “resend”, the wallpaper is formatted to fit the telephone's display and to show the appropriate area of interest (312). The wallpaper file is then delivered to the telephone using the process shown in FIG. 2. If no at 308, a “not compatible” is displayed (330).

The ringtone compatibility is checked (314) by identifying in the phone attributes record of handset database 30 ringtone formats and DRM types supported (316).

The ringtones vendors' DRM requirements and ringtones parents' children's formats are identified (318) and it is determined if the telephone has compatible DRM or if no DRM is required (320). If yes, it is determined if the parent ringtone has a compatible child (322). If yes at 322, the ringtones are mapped and displayed that do not require DRM or have the same DRM requirement that are supported by the telephone (324). A “re-send” button will also be displayed. If the user clicks on “re-send”, the best quality compatible ringtone child is sent and delivered to the telephone (326) using the process shown in FIG. 2. If no at 320 or 322, a “not compatible” is displayed (330).

The applications compatibility is checked (328) by identifying in the phone attributes record of handset database 30 application formats and DRM types supported (329).

The applications vendors' DRM requirements and applications parents' children's builds are identified (332) and it is determined if the telephone has compatible DRM or if no DRM is required (334). If yes, it is determined if the parent application has a compatible child (340). If yes at 340, the applications that do not require DRM or have the same DRM requirement that are supported by the telephone are mapped and displayed (342). A “re-send” button will also be displayed. If the user clicks on “re-send”, the compatible application child build is delivered to the telephone (344) using the process shown in FIG. 2. If no at 334 or 340, a “not compatible” is displayed (336).

As disclosed, the system in accordance with embodiments of the present invention remotely stores references or pointers to content in a user's locker. The content can be downloaded to the user's mobile cellular telephone even when the user switches telephones, while automatically accounting for DRM and download restrictions.

In general, as disclosed above, embodiments of the present invention before downloading the content must retrieve the content that is pointed to by the reference pointer. In some circumstances, the retrieval is done by formatting the content (e.g., when the content is wallpaper) while in other circumstances, the content is retrieved by mapping the reference to a child file of a master file, where the child file is suitable for the requesting handset types (e.g., when the content is ringtones or applications). In one embodiment, the different types of retrieval arise because wallpaper is relatively quickly able to be formatted on the fly, while the other content cannot be formatted in a timely matter. Therefore, different versions of this content is stored as child files either locally or by 3^{rd} party content providers via an application program interface (“API”).

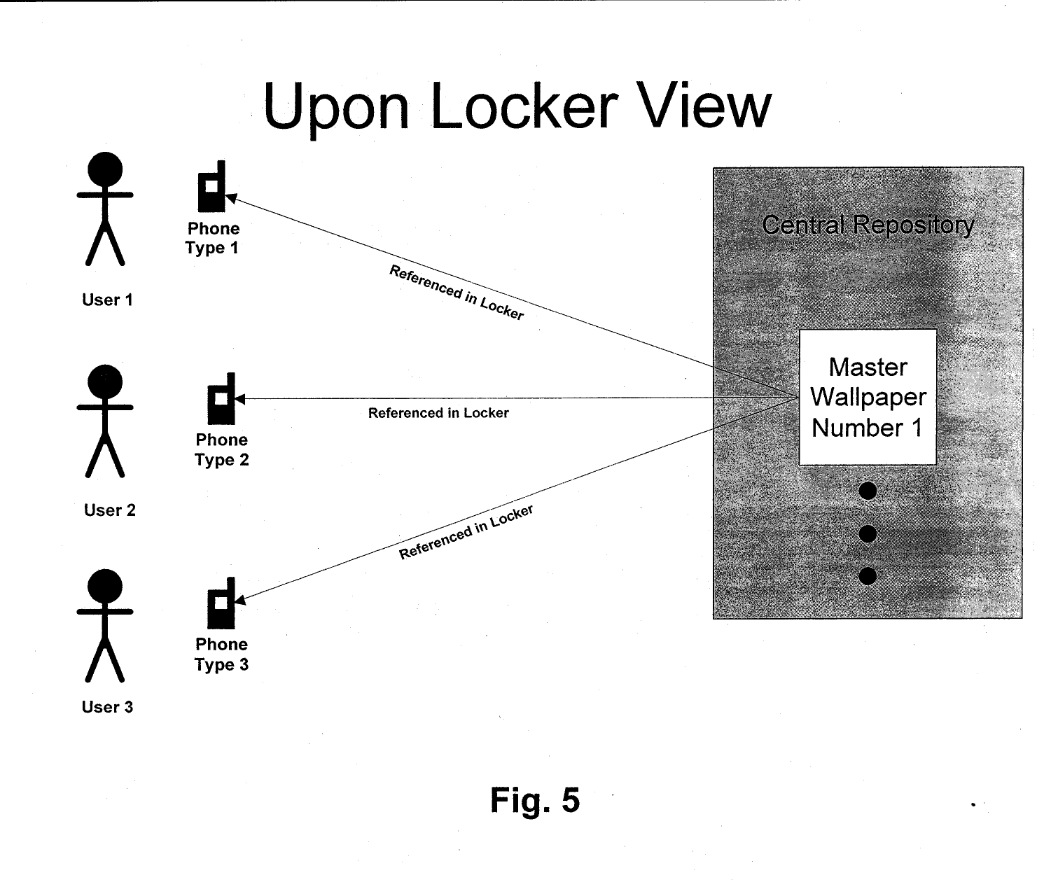

FIGS. 5-10 illustrate an example of retrieving wallpaper or other content that is formatted, and applications and other content that is merely mapped in accordance with an embodiment of the present invention. The example of FIGS. 5-10 concern three users 1-3 having phone types 1-3 respectively.

FIGS. 5-7 illustrate formatting the content for retrieval. In FIG. 5, upon locker view, the users access the locker and see references to master copies of wallpapers/screensavers (images) they have purchased. All wallpapers/screensavers purchased are always displayed as compatible since wallpapers/screensavers are compatible with all phones in one embodiment.

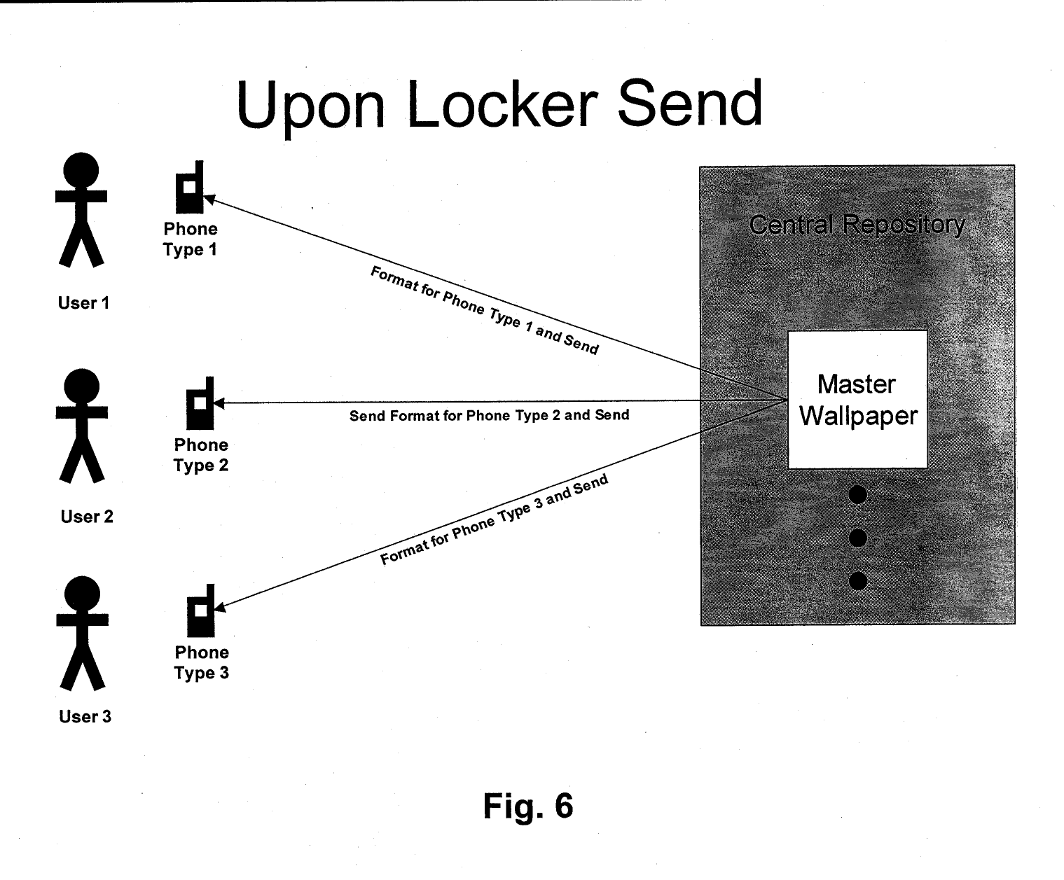

In FIG. 6, upon locker send, wallpapers/screensavers selected for re-download are formatted for phone before delivery (wallpapers are compatible with all phones).

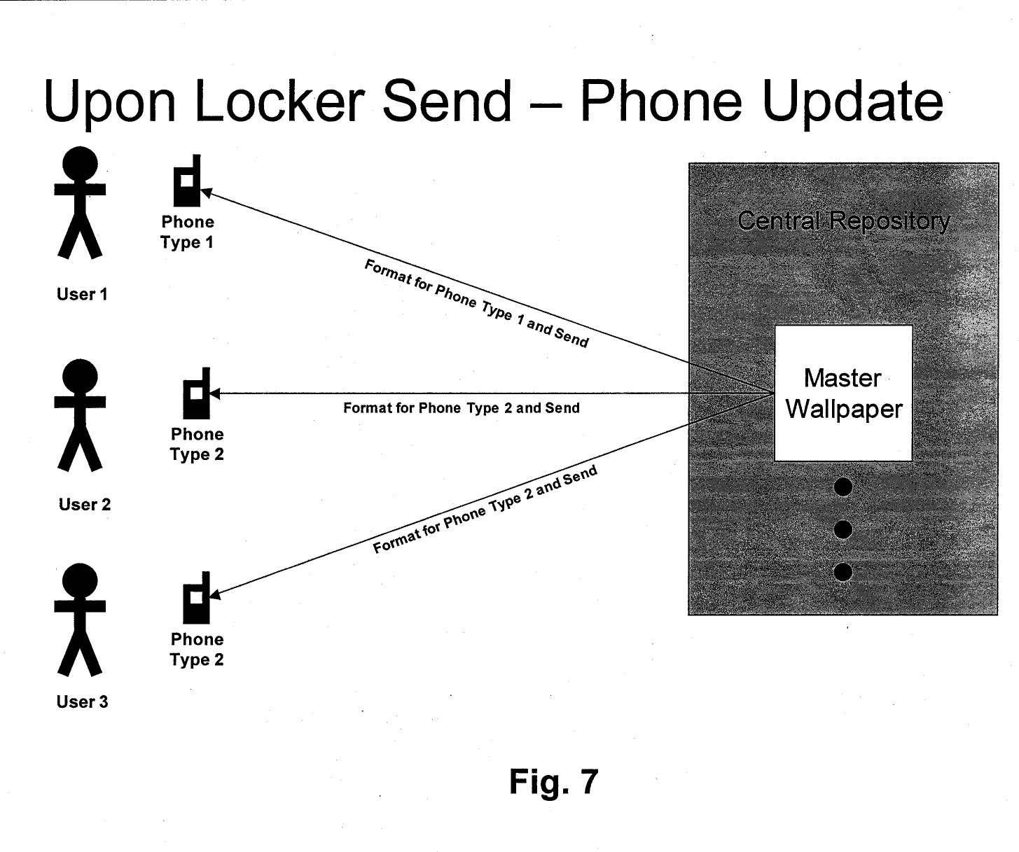

In FIG. 7, upon locker send for a phone update, user 3 changes their phone type, and the system displays content compatibility for the new phone type based on the locker phone settings. In this case, content is always compatible and content is formatted for the phone before delivery. Therefore, the display of content does not change from FIG. 5. This type of on-the-fly formatting may be performed in one embodiment on any content that requires low processor overhead to format, such as wallpaper/screensavers.

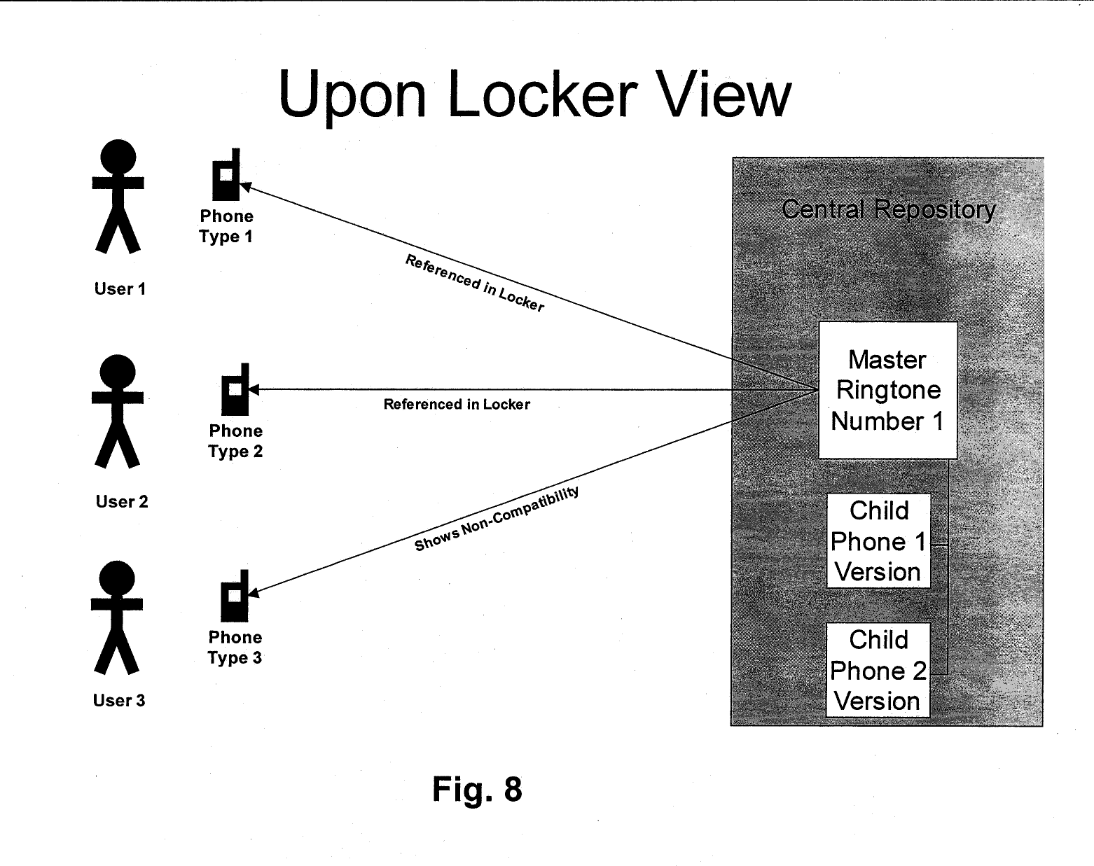

FIGS. 8-10 illustrates mapping the content for retrieval. In FIG. 8, upon locker view, the locker displays references to master copies of ringtones (sounds) the user has purchased. Upon entering the locker a check is made to see if a compatible version (child) is available for the phone. If not available the non-compatibility is displayed, and the file is not available for download to the phone.

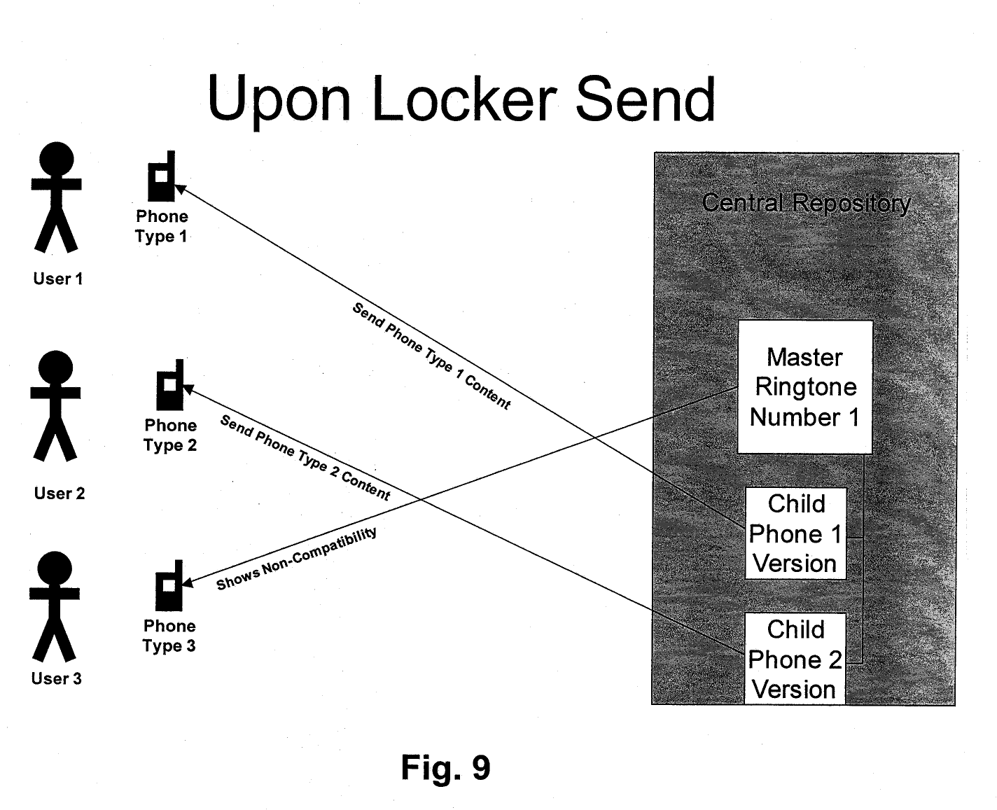

In FIG. 9, upon locker view, the user is able to select a ringtone for re-download if a compatible version (child) is available. The compatible version is mapped to the reference. Upon re-download the locker delivers the correct version for the phone. If a compatible version is not available, non-compatibility is displayed, and a download cannot be performed.

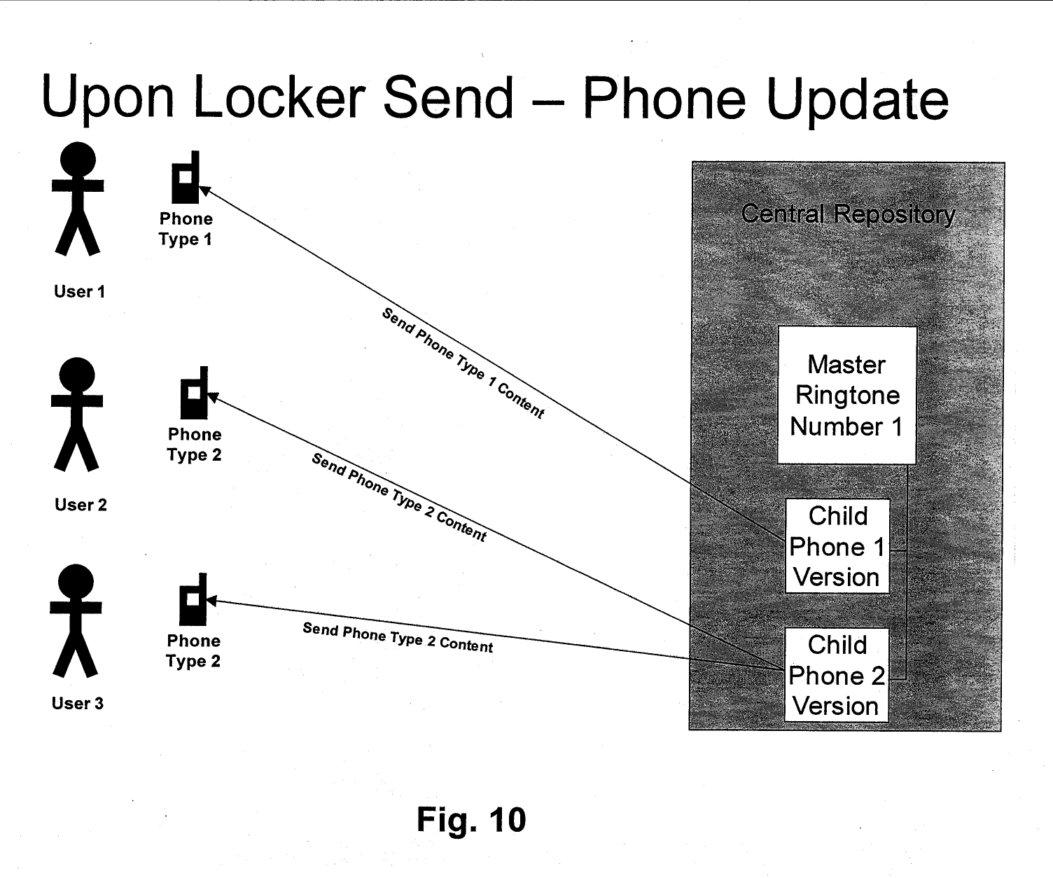

In FIG. 10, upon locker send for a phone update, user 3 changes phone type. A check is made to see if a compatible version (child) is available for the phone. If available, the version is mapped to the reference and the user can re-download content with the locker delivering the correct version for the phone. If not available, non-compatibility is displayed, and a download cannot be performed.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A system for downloading content to a first mobile telephone, said system comprising:
a first storage area storing a plurality of files, wherein said files correspond to mobile telephone content;
a first database storing one or more first content references, wherein each of said first content references point to one or more of said plurality of files, and further storing content attributes of the mobile telephone content, wherein said first content references are assigned to a first user; and
a user interface that allows the first user to view said first content references.

2. The system of claim 1, further comprising:
said first database further storing telephone attributes of the first mobile telephone; and
a content delivery system that retrieves the one or more of said plurality of files pointed to by said first content references for downloading into the first mobile telephone based on the telephone attributes of the first mobile telephone and content attributes of the mobile telephone content.

3. The system of claim 2, wherein said retrieves comprises formatting the one or more of said files based on a match of the content attributes with the telephone attributes.

4. The system of claim 2, wherein said retrieves comprises mapping to the one or more of said files based on a match of the content attributes with the telephone attributes.

5. The system of claim 2, wherein said user interface allows the first user to view an identity of said plurality of files.

6. The system of claim 5, wherein said user interface allows the first user to purchase new content that corresponds to said plurality of files, and wherein said purchase creates a new first content reference in said first database.

7. The system of claim 1, wherein said content attributes comprise at least one of the following: ownership rights, digital rights management attributes, the compatibility of the content with different types of mobile telephones and wireless carrier compatibility.

8. The system of claim 2, wherein said telephone attributes comprises at least one of the following: screen size, memory space, audio codec type, video codec type, operating system and digital rights management.

9. The system of claim 2, further comprising:
said first database storing one or more second content references, wherein each of said second content references point to one or more of said files and are assigned to a second user;
wherein said user interface allows the first user to view said second content references.

10. A method of remotely storing content for downloading into a mobile telephone; said method comprising:
for a first user, storing a plurality of first content references, wherein each first content reference references content that is associated with the first user;
receiving a request from the first user to download first user associated content to the first mobile telephone;
determining first telephone attributes for the first mobile telephone;
retrieving the first user associated content based on the first telephone attributes; and
delivering the retrieved first user associated content via a wireless carrier network to the first mobile telephone.

11. The method of claim 10, further comprising:
determining first content attributes of the first user associated content before delivering.

12. The method of claim 11, wherein the first user associated content comprises content that is owned by the first user.

13. The method of claim 11, wherein said first user associated content comprises a plurality of files, and retrieving comprises formatting the plurality of files based on a match of the content attributes with the telephone attributes.

14. The method of claim 11, wherein said first user associated content comprises a plurality of files, and said retrieving comprises mapping to the plurality of files based on a match of the content attributes with the telephone attributes.

15. The method of claim 11, wherein said first content attributes comprises at least one of the following: ownership rights, digital rights management attributes, the compatibility of the content with different types of mobile telephones and wireless carrier compatibility.

16. The method of claim 10, wherein said first telephone attributes comprises at least one of the following: screen size, memory space, audio codec type, video codec type, operating system and digital rights management.

17. The method of claim 10, further comprising:
allowing a second user to view the first content references.

18. The method of claim 10, wherein said delivering comprises:
providing a link to the content via a packet-based network to a wireless carrier.

19. A method of managing telephone content comprising:
providing a first locker for a first user, said first locker comprising references to cellular telephone content;
storing telephone attributes for a plurality of telephone;
receiving a request from the first user to download telephone content to a first telephone;
retrieving the content based on the telephone attributes for the first telephone; and
initiating a transfer of the content via a telephone carrier to the first telephone.

20. The method of claim 19, further comprising:
storing download limitations for the telephone content; and
based on the download limitations, determining restrictions on the content before initiating the transfer.

21. The method of claim 20, wherein the download limitations comprises a limit on a number of permissible downloads of the content.

22. The method of claim 19, further comprising:
receiving a request from the first user to download telephone content to a second telephone;
retrieving the content based on the telephone attributes for the second telephone; and
initiating a transfer of the content via the telephone carrier to the second telephone.

23. The method of claim 22, wherein said first telephone has a different operating system from said second telephone.

24. The method of claim 22, wherein said first telephone requires different content format from said second telephone.

25. The method of claim 22, wherein said first telephone requires different digital rights management schemes from said second telephone.

26. The method of claim 22, wherein said first telephone has a different video codec from said second telephone.

27. The method of claim 22, wherein said first telephone has a different audio codec from said second telephone.

28. The method of claim 22, wherein said first telephone has a different screen size from said second telephone.

29. The method of claim 22, wherein said first telephone has a different amount of memory from said second telephone.

30. The method of claim 22, wherein said retrieving the content based on the telephone attributes for the second telephone comprises formatting the content based on a match of the content attributes with the telephone attributes for the second telephone.

31. The method of claim 22, wherein said retrieving the content based on the telephone attributes for the second telephone comprises mapping the content based on a match of the content attributes with the telephone attributes.

32. The method of claim 19, further comprising:
allowing a second user to browse said first locker.

33. The method of claim 19, further comprising:
storing the telephone content in a central location.

34. The method of claim 19, further comprising:
storing the telephone content at a remote location accessible via an application program interface.

35. A system for downloading content to a wireless cellular device, said system comprising:
a first storage area storing a plurality of files, wherein said files correspond to wireless cellular device content;
a first database storing one or more first content references, wherein each of said first content references point to one or more of said plurality of files, and further storing content attributes of the wireless cellular device content, wherein said first content references are assigned to a first user; and
a user interface that allows the first user to view said first content references.

36. The system of claim 35, further comprising:
said first database further storing wireless cellular device attributes of the wireless cellular device; and
a content delivery system that retrieves the one or more of said plurality of files pointed to by said first content references for downloading into the wireless cellular device based on the wireless cellular device attributes of the wireless cellular device and content attributes of the wireless cellular device content.

37. The system of claim 36, wherein said retrieves comprises formatting the one or more of said files based on a match of the content attributes with the wireless cellular device attributes.

38. The system of claim 36, wherein said retrieves comprises mapping to the one or more of said files based on a match of the content attributes with the wireless cellular device attributes.

39. The system of claim 36, wherein said user interface allows the first user to view an identity of said plurality of files.

40. The system of claim 39, wherein said user interface allows the first user to purchase new content that corresponds to said plurality of files, and wherein said purchase creates a new first content reference in said first database.
